(19) United States
(12) Patent Application Publication
(10) Pub. No.: US 2018/0039211 A1
(43) Pub. Date: Feb. 8, 2018

(54) FUSER MEMBERS

(71) Applicant: Xerox Corporation, Norwalk, CT (US)

(72) Inventors: Jin Wu, Pittsford, NY (US); Lin Ma, Pittsford, NY (US)

(73) Assignee: Xerox Corporation, Norwalk, CT (US)

(21) Appl. No.: 15/229,621

(22) Filed: Aug. 5, 2016

(51) Int. Cl. B32B 9/04; G03G 15/20

(52) U.S. Cl. CPC G03G 15/2057

(57) ABSTRACT

A fuser member comprising a boron nitride nanotube component and a fluoropolymer.

This disclosure is generally directed to fuser members useful in electrophotographic imaging apparatuses, including xerographic printing systems, digital, image on image, and transfix solid ink jet printing systems, and where the fuser member is comprised of a boron nitride nanotube component.

### BACKGROUND

In the process of xerography, a light image of an original to be copied is typically recorded in the form of a latent electrostatic image upon a photosensitive or a photoconductive member with subsequent rendering of the latent image visible by the application of particulate thermoplastic material, commonly referred to as toner. The visual toner image can be either fixed directly upon the photoconductor member, or transferred from the member to another support, such as a sheet of plain paper, with subsequent affixing by, for example, the application of heat and pressure of the image thereto.

To affix or fuse toner material onto a support member like paper, by heat and pressure, it is usually necessary to elevate the temperature of the toner and simultaneously apply pressure sufficient to cause the constituents of the toner to become tacky and coalesce. In both the xerographic as well as the electrographic recording arts, the use of thermal energy for fixing toner images onto a support member is known. Thus, to permanently fuse electroscopic toner onto a support surface, it is usually necessary to elevate the temperature of the toner to a point at which the constituents of the toner coalesce and become tacky. This heating causes the toner to flow to some extent into the fibers or pores of the support member. Thereafter, as the toner cools, solidification of the toner causes it to be firmly bonded to the support member, like paper.

More specifically, the thermal fusing of electroscopic toner images includes providing the application of heat and pressure substantially concurrently by various means, including a roll pair maintained in pressure contact, a belt member in pressure contact with a roll, and the like. Heat may be applied by heating one or both of the rolls, plate members or belt members. The fusing of the toner particles generally takes place when the proper combination of heat, pressure and contact time are provided.

One approach to the heat and pressure fusing of toner images onto a support has been to pass the support with the developed toner images thereon between a pair of pressure engaged roller members, at least one of which is internally heated. For example, the support may pass between a fuser roller and a pressure roller. During operation of a fusing system of this type, the support member to which the toner images are electrostatically adhered is moved through the nip formed between the rollers with the toner image contacting the fuser roll thereby to effect heating of the toner images within the nip.

Typically, thermoplastic resin particles are fused to a substrate by heating to a temperature of from about 90° C. to about 160° C. or higher, depending upon the softening range of the particular resin used in the toner. It may not be desirable, however, to raise the temperature of the substrate substantially higher than about 200° C. primarily because of the tendency of the substrate to discolor at such elevated temperatures particularly when the substrate is paper.

It is desirable in the fusing process that no or minimum offset of the toner particles from the support to the fuser member takes place during normal operations. Toner particles offset onto the fuser member may subsequently transfer to other parts of a xerographic machine or onto the support in subsequent copying and printing cycles.

Hot offset occurs when the temperature of the toner is raised to a point where the toner particles liquefy and a splitting of the molten toner takes place during the fusing operation with a toner portion remaining on the fuser member. The hot offset temperature is a measure of the release property of the fuser member, and accordingly, it is desirable to provide a fusing surface that has a low surface energy to permit the efficient release of toner. To ensure and maintain good release properties for the fuser member, it has become known to apply release agents thereto to ensure that the toner is completely released from the fuser member during the fusing operation. Typically, these release agents are applied as thin films of, for example, silicone oils. In addition to preventing hot offset, it is desirable to provide a large temperature operational latitude. By operational latitude, it is intended to mean, for example, the difference in temperature between the minimum temperature required to fix the toner to the paper, often referred to as the minimum fix temperature, and the temperature at which the hot toner will offset to the fuser member, or the hot offset temperature.

In use, desirable properties of fuser members include thermal conductivity and acceptable mechanical properties such as hardness. A high fuser member thermal conductivity is of value because the fuser member should adequately conduct heat to provide sufficient controlled heat to the toner particles for fusing. Mechanical properties of the fuser member are also of value because the fuser member should retain its desired rigidity and elasticity, without being degraded in a short period of time. In order to increase the thermal conductivity of the fuser member, it has been conventional to add quantities of conductive particles as fillers, such as metal oxide fillers, however, the filler loading, up to 60 percent, can be substantial which tends to adversely affect the mechanical properties of the fuser member coating layer, and renders this member harder and more less resistant to wear.

There is a need for fusing members that substantially avoid or minimize the disadvantages of a number of known fusing members.

Also, there is a need for fuser member mixtures where there is enhanced the thermal and electrical conductivity properties thereof, and where the fuser member possesses robust mechanical properties.

Additionally, there is a need for fuser members that permit toner compositions to fuse at low temperatures, and that allow wider toner fusing temperature latitudes.

Yet further, there is a need for fusing members where a multitude of different toner compositions can be used resulting in decreased costs to manufacturers.

Furthermore, there is a need for fuser members where toner offset is minimal, or where toner offset is avoided in xerographic imaging and printing systems.

There is also a need for composite fuser members that possess excellent and improved thermally conductive characteristics.

Moreover, there is a need for fuser members that can be prepared by current manufacturing methods, and with little or no capital investments.

There is also a need for economical endless seamless fusing members, that is with an absence of any seams or visible joints in the members, that are selected for the heat fusing of developed images in xerographic processes.

Also, there is a need for fuser members with superb mechanical properties, outstanding thermal conductivity characteristics, and excellent stability over extended time periods.

A need also exists to minimize the repair or replacement of fuser members by increasing or improving the thermal conductivity characteristics thereof.

These and other needs are achievable in embodiments with the fuser members and components thereof disclosed herein.

### SUMMARY

There is disclosed a fuser member comprising a boron nitride nanotube component.

Also disclosed is a xerographic fuser member comprising a layer comprising a mixture of boron nitride nanotubes and a fluoropolymer.

Moreover, disclosed is a fuser member comprising in the configuration of a layer a mixture of a plurality of boron nitride nanotubes present in an amount of from about 0.01 weight percent to about 10 weight percent of the solids, and a fluoropolymer present in an amount of from about 99.99 weight percent to about 90 weight percent of the solids.

### FIGURES

The following Figures are provided to further illustrate the fuser members disclosed herein.

FIG. 1 illustrates an exemplary embodiment of a fuser member of the present disclosure.

FIG. 2 illustrate an exemplary embodiment of a two layered fuser member of the present disclosure.

FIG. 3 illustrates an exemplary embodiment of a three layered fusing member of the present disclosure.

### EMBODIMENTS

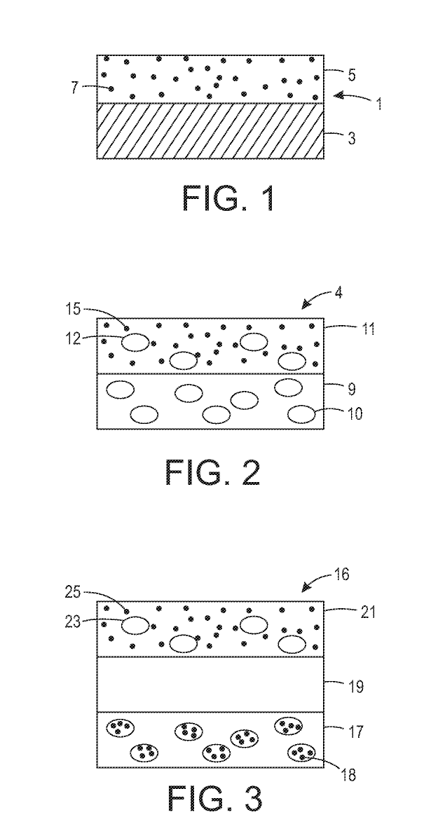

In FIG. 1, an exemplary embodiment of the present disclosure, there is illustrated a fuser member 1, an optional supporting substrate layer 3, and a top coating layer 5, comprising boron nitride nanotube components or particles 7.

In FIG. 2, an exemplary embodiment of the present disclosure, there is illustrated a two layered fuser member 4, comprising a supporting substrate layer 9 containing optional boron nitride nanotube particles 10, a top coating layer 11, comprising boron nitride nanotubes 12, and particles of a polymer 15.

In FIG. 3, an exemplary embodiment of the present disclosure, there is illustrated a three layered fuser member 16 comprising a supporting substrate layer 17 containing optional boron nitride nanotube particles 18, an optional intermediate polymer layer or functional layer 19, and a fuser topcoat surface layer 21 comprising boron nitride nanotube particles 23, and particles of a fluoropolymer 25.

Boron Nitride Nanotubes

There are several publications that illustrate the preparation of boron nitride nanotubes, and thermally conductive boron nitride nanotubes (BNNT) which can be selected for the disclosed herein fuser members, such as the article “Nanotubes Boron Nitride Laser Heated at High Pressure”, Applied Physics Letters 69, 2045 (1996), with the listed authors of D. Golberg, Y. Bando, M. Eremets, K. Takemura, K. Kurashima and H. Yusa, the disclosure of this article being totally incorporated herein by reference; and the article “Boron Nitride Nanotubes, Advanced Materials 2007”, 19, 2413-2432 with the listed authors Dmitri Goldberg, Yoshio Bando, Chengchun Tang, and Chunyi Zhi, the disclosure of this article being totally incorporated herein by reference.

Also selected for the disclosed fuser members are the boron nitride nanotubes illustrated in U.S. Pat. No. 8,206,674, the disclosure of which is totally incorporated herein.

Boron nitride nanotubes (BNNT) are available from a number of sources such as BNNT, LLC, Newport News, Va., and Tekna Advanced Material of Canada, which has commercially offered these nanotubes in collaboration with the National Research Council of Canada. The commercial boron nitride nanotube components are available as BNNT P1 Beta from BNNT, LLC and TEKMAT BNNT-R from Tekna Advanced Material, where there is disclosed that the diameter of the boron nitride nanotubes are, for example, about 5 nanometers, and the tube length is, for example, about 200 microns with a BET surface area up to about 300 m²/gram, such as from about 100 m²/gram to about 275 m²/gram. Recently discovered boron nitride nanotube (BNNT) materials have been reported as being 100 times stronger than steel, and stable up to 900° C. versus 400° C. for carbon nanotubes.

Nanotube or nanotubes refers, for example, to elongated materials or particles, including organic and inorganic materials having at least one minor dimension, for example, a diameter of about 100 nanometers or less, and more specifically, a diameter of from about 1 to about 75 nanometers, from about 5 to about 50 nanometers, from about 2 to about 25 nanometers, or from about 3 to about 7 nanometers. In various disclosed embodiments, nanotubes can have an inside diameter and an outside diameter. For example, the inside diameter can range from about 0.5 to about 20 nanometers, while the outside diameter can range from about 1 to about 100 nanometers. Also, the nanotubes can have an aspect ratio of, for example, from about 1 to about 10,000.

In embodiments, the boron nitride nanotubes selected for the disclosed fuser members have an average outside diameter of from about 1 nanometer to about 100 nanometers, are of an average length of from about 10 microns to about 500 microns as determined by known SEM measurements, and a surface area of from about 50 m²/g to about 500 m²/g as determined by known BET analysis.

Further, nanotubes include single wall nanotubes, such as single wall boron nitride nanotubes (SWBNNTs), multi-wall nanotubes, such as multi-wall boron nitride nanotubes (MWBNNTs), and their various functionalized and derivatized fibril forms such as nanofibers.

Polymers

The boron nitride nanotubes disclosed herein can be incorporated in, mixed with, or dispersed in various suitable polymers, such as polyesters, polyorganosilanes, fluoropolymers, and the like, to form a composite, a mixture, or a matrix of the polymer and the boron nitride nanotube particles.

Fluoropolymer examples include those containing a monomeric repeat unit selected, for example, from the group consisting of tetrafluoroethylene, perfluoro(methyl vinyl ether), perfluoro(propyl vinyl ether), perfluoro(ethyl vinyl ether), vinylidene fluoride, hexafluoropropylene, and mixtures thereof. The fluoropolymers can include linear or branched polymers, and/or crosslinked fluoroelastomers.

Examples of suitable fluoropolymers can include, but are not limited to, i) copolymers of vinylidenefluoride and hexafluoropropylene; ii) terpolymers of vinylidenefluoride, hexafluoropropylene and tetrafluoroethylene; and iii) tetrapolymers of vinylidenefluoride, hexafluoropropylene, tetrafluoroethylene, and a cure site monomer.

Specific examples of fluoropolymers selected for the disclosed fuser members include TEFLON PFA® (polyfluoroalkoxypolytetrafluoroethylene), TEFLON PTFE® (polytetrafluoroethylene), TEFLON FEP® (fluorinated ethylenepropylene copolymers), VITON A® (copolymers of hexafluoropropylene (HFP) and vinylidene fluoride (VDF or VF₂)), VITON B® (terpolymers of tetrafluoroethylene (TFE), vinylidene fluoride (VDF) and hexafluoropropylene (HFP)), and VITON GF®, (tetrapolymers including TFE, VF₂, HFP), VITON E®, VITON E 60C®, VITON E430®, VITON 910®, VITON GH® or VITON GF®, and VITON ETP®, all available from E.I. DuPont de Nemours, Inc.

Other commercially available fluoropolymers that can be selected for the disclosed fuser members include, for example, FLUOREL 2170®, FLUOREL 2174®, FLUOREL 2176®, FLUOREL 2177® and FLUOREL LVS 76®, FLUOREL® being a registered trademark of 3M Company; AFLAS™ a poly(propylene-tetrafluoroethylene), and FLUOREL II® (LII900) a poly(propylene-tetrafluoroethylenevinylidenefluoride), both available from 3M Company; the Tecnoflons identified as FOR-60KIR®, FOR-LHF®, NM®, FOR-THF®, FOR-TFS®, TH®, NH®, P757®, TNS®, T439®, PL958®, BR9151® and TN505®, available from Ausimont Inc.

Various suitable amounts of the polymers, such as the fluoropolymers, can be selected, such as from about 99.99 weight percent to about 90 weight percent, from about 99.99 weight percent to about 95 weight percent, from about 99.95 weight percent to about 95 weight percent, from about 99.9 weight percent to about 99.5 weight percent, of the solids and the like, and where the amount of the fluoropolymer and the boron nitride nanotubes total about 100 percent of the solids.

The boron nitride nanotubes are present in the polymer to form a matrix, a mixture, or a composite, and where the amount of the nanotubes are, for example, from about 0.01 to about 10 weight percent, from about 0.01 to about 5 weight percent, from about 0.05 to about 5 weight percent, from about 0.1 to about 0.5 weight percent, from about 0.02 to about 0.05 weight percent, from about 0.03 to about 0.3 weight percent, from about 0.01 to about 0.05 weight percent, from about 0.02 to about 1 weight percent, from about 0.05 to about 1 weight percent, from about 0.01 to about 1 weight percent, from about 0.1 to about 3 weight percent, and from about 1 to about 3 weight percent based on the percent solids of, for example, the boron nitride nanotubes, the polymer, like the fluoropolymer and optional known additives, if any, when present.

In the configuration of a layer, the thickness of the boron nitride nanotubes can be, for example, from about 10 to about 100 microns, from about 20 to about 80 microns, or from about 40 to about 60 microns.

Intermediate Layer or Functional Layer

Examples of materials selected for the functional intermediate layer (also referred to as cushioning layer or intermediate layer) include fluorosilicones, silicone rubbers, such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials that can be selected include siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; Dow Corning SYLGARD 182, commercially available LSR rubbers such as Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR. The functional layer provides, for example, elasticity, and this layer can include inorganic particles, for example SiC or Al₂O₃, as required.

The intermediate layer or functional layer may be comprised of the fluoropolymers disclosed herein for the boron nitride nanotube layer, such as copolymers of vinylidenefluoride, hexafluoropropylene, and tetrafluoroethylene, like those available as VITON A®; terpolymers of vinylidenefluoride, hexafluoropropylene, and tetrafluoroethylene known commercially as VITON B®; and tetrapolymers of vinylidenefluoride, hexafluoropropylene, tetrafluoroethylene, and a cure site monomer, available as VITON GH® or VITON GF®; VITON E®, VITON E 60C®, VITON E430®, VITON 910®, and VITON ETP®. The cure site monomer can be 4-bromoperfluorobutene-1, 1,1-dihydro-4-bromoperfluorobutene-1, 3-bromoperfluoropropene-1, 1,1-dihydro-3-bromoperfluoropropene-1, or any other suitable known cure site monomer, such as those commercially available from E.I. DuPont.

The thickness of the functional intermediate layer is, for example, from about 25 microns to about 1,000 microns, from about 100 microns to about 700 microns, or from about 150 microns to about 500 microns as determined by known methods such as measurement with a Permascope.

Optional Supporting Substrates

Exemplary supporting substrate materials include polyimides, polyamideimides, polyetherimides, mixtures thereof, and the like. More specifically, examples of optional supporting substrates are polyimides inclusive of known low temperature, and rapidly cured polyimide polymers, such as VTEC™ PI 1388, 080-051, 851, 302, 203, 201, and PETI-5, all available from Richard Blaine International, Incorporated, Reading, Pa., and the like. The thermosetting polyimides selected can be cured at temperatures of from about 180° C. to about 260° C. over a period of time, such as from about 10 to about 120 minutes, or from about 30 to about 60 minutes, and generally have a number average molecular weight of from about 5,000 to about 500,000, or from about 10,000 to about 100,000, and a weight average molecular weight of from about 50,000 to about 5,000,000, or from about 100,000 to about 1,000,000, as determined by GPC or as reported by the entities that prepare these polyimides. Also, for the supporting substrate there can be selected thermosetting polyimides that can be cured at temperatures of above 300° C., such as PYRE M.L.® RC-5019, RC-5057, RC-5069, RC-5097, and RC-5053, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyimides selected as the supporting substrate for the fuser member illustrated herein can be formed from a polyimide precursor of a polyamic acid that includes one of a polyamic acid of pyromellitic dianhydride/4,4′-oxydianiline, a polyamic acid of pyromellitic dianhydride/phenylenediamine, a polyamic acid of biphenyl tetracarboxylic dianhydride/4,4′-oxydianiline, a polyamic acid of biphenyl tetracarboxylic dianhydride/4,4′-diaminobenzene, a polyamic acid of biphenyl tetracarboxylic dianhydride/phenylenediamine, a polyamic acid of benzophenone tetracarboxylic dianhydride/4,4′-oxydianiline, a polyamic acid of benzophenone tetracarboxylic dianhydride/4,4′-oxydianiline/phenylenediamine, and the like, and mixtures thereof. After curing, the resulting polyimides include a polyimide of pyromellitic dianhydride/4,4′-oxydianiline, a polyimide of pyromellitic dianhydride/phenylenediamine, a polyimide of biphenyl tetracarboxylic dianhydride/4,4′-oxydianiline, a polyimide of biphenyl tetracarboxylic dianhydride/phenylenediamine, a polyimide of benzophenone tetracarboxylic dianhydride/4,4′-oxydianiline, a polyimide of benzophenone tetracarboxylic dianhydride/4,4′-oxydianiline/phenylenediamine, and mixtures thereof.

Specific examples of polyamic acids include a polyamic acid of pyromellitic dianhydride/4,4-oxydianiline, with the trade name of PYRE-M.L.®, RC-5019 (about 15 to 16 weight percent in N-ethyl-2-pyrrolidone, NMP), RC-5083 (about 18 to 19 weight percent in NMP/DMAc 15/85), or RC-5057 (about 14.5 to 15.5 weight percent in NMP/aromatic hydrocarbon 80/20), and all commercially available from Industrial Summit Technology Corporation, Parlin, N.J.; a polyamic acid of biphenyl tetracarboxylic dianhydride/p-diaminobenzene, commercially available as U-VARNISH A and S (about 20 weight percent in NMP), both available from UBE America Incorporated, New York, N.Y., or available from Kaneka Corporation, Texas; PI-2610 (about 10.5 weight percent in NMP), and PI-2611 (about 13.5 weight percent in NMP), both available from HD MicroSystems, Parlin, N.J.; DURIMIDE® 100, commercially available from FUJIFILM Electronic Materials Incorporated, United States, mixtures thereof, and the like.

More specifically, polyamic acid or esters of polyamic acid examples that can be selected for the formation of a polyimide are prepared by the reaction of a dianhydride and a diamine. Suitable dianhydrides selected include aromatic dianhydrides and aromatic tetracarboxylic acid dianhydrides, such as, for example, 9,9-bis(trifluoromethyl)xanthene-2,3,6,7-tetracarboxylic acid dianhydride, 2,2-bis(3,4-dicarboxyphenyl)hexafluoropropane dianhydride, 2,2-bis((3,4-dicarboxyphenoxy) phenyl)hexafluoropropane dianhydride, 4,4′-bis(3,4-dicarboxy-2,5,6-trifluorophenoxy) octafluorobiphenyl dianhydride, 3,3′,4,4′-tetracarboxybiphenyl dianhydride, 3,3′,4,4′-tetracarboxybenzophenone dianhydride, di-(4-(3,4-dicarboxyphenoxy)phenyl)ether dianhydride, di-(4-(3,4-dicarboxyphenoxy)phenyl) sulfide dianhydride, di-(3,4-dicarboxyphenyl)methane dianhydride, di-(3,4-dicarboxyphenyl)ether dianhydride, 1,2,4,5-tetracarboxybenzene dianhydride, 1,2,4-tricarboxybenzene dianhydride, butanetetracarboxylic dianhydride, cyclopentanetetracarboxylic dianhydride, pyromellitic dianhydride, 1,2,3,4-benzenetetracarboxylic dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 3,4,9,10-perylenetetracarboxylic dianhydride, 2,3,6,7-anthracene tetracarboxylic dianhydride, 1,2,7,8-phenanthrenetetracarboxylic dianhydride, 3,3′,4,4′-biphenyltetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, bis(3,4-dicarboxyphenyl)sulfone dianhydride, bis(2,3-dicarboxyphenyl)sulfone 2,2-bis(3,4-dicarboxyphenyl)-1,1,1,3,3,3-hexafluoropropane dianhydride, 2,2-bis(3,4-dicarboxyphenyl)-1,1,1,3,3,3-hexachloropropane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy) diphthalic dianhydride, 4,4′-(m-phenylenedioxy)diphthalic dianhydride, 4,4′-diphenylsulfidedioxybis(4-phthalic acid)dianhydride, 4,4′-diphenylsulfonedioxybis(4-phthalic acid)dianhydride, methylenebis(4-phenyleneoxy-4-phthalic acid)dianhydride, ethylidenebis(4-phenyleneoxy-4-phthalic acid)dianhydride, isopropylidenebis(4-phenyleneoxy-4-phthalic acid)dianhydride, hexafluoroisopropylidenebis(4-phenyleneoxy-4-phthalic acid)dianhydride, and the like.

Exemplary diamines selected suitable for use in the preparation of the polyamic acid include 4,4′-bis-(m-aminophenoxy)-biphenyl, 4,4′-bis-(m-aminophenoxy)-diphenyl sulfide, 4,4′-bis-(m-aminophenoxy)-diphenyl sulfone, 4,4′-bis-(p-aminophenoxy)-benzophenone, 4,4′-bis-(p-aminophenoxy)-diphenyl sulfide, 4,4′-bis-(p-aminophenoxy)-diphenyl sulfone, 4,4′-diamino-azobenzene, 4,4′-diaminobiphenyl, 4,4′-diaminodiphenylsulfone, 4,4′-diamino-p-terphenyl, 1,3-bis-(gamma-aminopropyl)-tetramethyl-disiloxane, 1,6-diaminohexane, 4,4′-diaminodiphenylmethane, 3,3′-diaminodiphenylmethane, 1,3-diaminobenzene, 4,4′-diaminodiphenylether, 2,4′-diaminodiphenylether, 3,3′-diaminodiphenylether, 3,4′-diaminodiphenylether, 1,4-diaminobenzene, 4,4′-diamino-2,2′,3,3′,5,5′,6,6′-octafluorobiphenyl, 4,4′-diamino-2,2′,3,3′,5,5′,6,6′-octafluorodiphenyl ether, bis[4-(3-aminophenoxy)-phenyl] sulfide, bis[4-(3-aminophenoxy)phenyl] sulfone, bis[4-(3-aminophenoxy)phenyl] ketone, 4,4′-bis(3-aminophenoxy)biphenyl, 2,2-bis[4-(3-aminophenoxy)phenyl]-propane, 2,2-bis[4-(3-aminophenoxy)phenyl]-1,1,1,3,3,3-hexafluoropropane, 4,4′-diaminodiphenyl sulfide, 4,4′-diaminodiphenyl ether, 4,4′-diaminodiphenyl sulfone, 4,4′-diaminodiphenyl methane, 1,1-di(p-aminophenyl) ethane, 2,2-di(p-aminophenyl)propane, and 2,2-di(p-aminophenyl)-1,1,1,3,3,3-hexafluoropropane, and the like, and mixtures thereof.

The dianhydrides and diamines are, for example, selected in a weight ratio of from about 20:80 to about 80:20, and more specifically, in an about 50:50 weight ratio. The above aromatic dianhydride like aromatic tetracarboxylic acid dianhydrides, and diamines like aromatic diamines are used singly or as a mixture, respectively.

Polyimide examples selected for the fuser members supporting substrates are, for example, represented by at least one of the following formulas/structures, and mixtures thereof

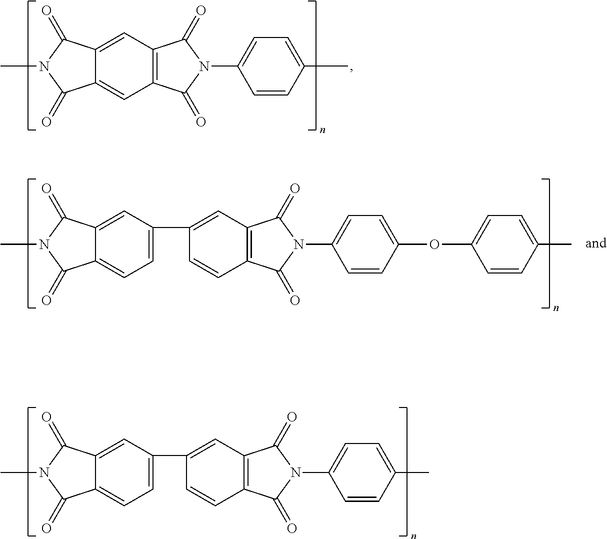

where n represents the number of repeating segments of, for example, from about 5 to about 3,000, from about 50 to about 2,000, from about 50 to about 1,500, from about 200 to about 1,200, from about 1,000 to about 2,000, or from about 1,200 to about 1,800.

Examples of polyamideimides that can be selected as supporting substrates are VYLOMAX® HR-11NN (15 weight percent solution in N-methylpyrrolidone, Tg=300° C., and M_{w}=45,000), HR-12N2 (30 weight percent solution in N-methylpyrrolidone/xylene/methyl ethyl ketone=50/35/15, Tg=255° C., and M_{w}=8,000), HR-13NX (30 weight percent solution in N-methylpyrrolidone/xylene=67/33, Tg=280° C., and M_{w}=10,000), HR-15ET (25 weight percent solution in ethanol/toluene=50/50, Tg=260° C., and M_{w}=10,000), HR-16NN (14 weight percent solution in N-methylpyrrolidone, Tg=320° C., and M_{w}=100,000), all commercially available from Toyobo Company of Japan, and TORLON® Al-10 (Tg=272° C.), commercially available from Solvay Advanced Polymers, LLC, Alpharetta, Ga.

Examples of specific polyetherimide supporting substrates selected are ULTEM® 1000 (T_{g}=210° C.), 1010 (T_{g}=217° C.), 1100 (T_{g}=217° C.), 1285, 2100 (T_{g}=217° C.), 2200 (T_{g}=217° C.), 2210 (T_{g}=217° C.), 2212 (T_{g}=217° C.), 2300 (T_{g}=217° C.), 2310 (T_{g}=217° C.), 2312 (T_{g}=217° C.), 2313 (T_{g}=217° C.), 2400 (T_{g}=217° C.), 2410 (T_{g}=217° C.), 3451 (T_{g}=217° C.), 3452 (T_{g}=217° C.), 4000 (T_{g}=217° C.), 4001 (T_{g}=217° C.), 4002 (T_{g}=217° C.), 4211 (T_{g}=217° C.), 8015, 9011 (T_{g}=217° C.), 9075, and 9076, all commercially available from Sabic Innovative Plastics.

The supporting substrate can be of various thicknesses such as, for example, from about 10 to about 300 microns, from about 100 to about 175 microns, from about 50 to about 150 microns, from about 75 to about 125 microns, and from about 50 to about 75 microns.

Solvents

For the preparation of the top coating boron nitride nanotube and polymer mixture, and the application of this mixture to a supporting substrate, there can be selected various suitable solvents including, but not limited to methyl ethyl ketone (MEK), methyl isobutyl ketone (MIBK), methyl-tertbutyl ether (MTBB), methyl n-amyl ketone (MAK), tetrahydrofuran (THF), water, alkalis, methyl alcohol, ethyl alcohol, acetone, ethyl acetate, butyl acetate, or any other low molecular weight carbonyls; polar solvents, Wittig reaction solvents such as dimethyl formamide (DMF), dimethyl sulfoxide (DMSO) and N-methyl 2 pyrrolidone (NMP), can be used to prepare the coating composition dispersion.

For example, the composition coating dispersion can be formed by first dissolving or dispersing the polymer in a suitable solvent, followed by adding a plurality of boron nitride nanotube particles to the solvent resulting mixture in an amount to provide the desired properties, such as the desired thermal conductivity or mechanical strength. The mixing and dissolving can be accomplished by mechanical processes, such as by using an agitation sonication or attritor, ball milling/grinding, to facilitate the mixing of the dispersion. For example, an agitation set-up fitted with a stir rod and TEFLON blade can be used to thoroughly mix the boron nitride nanotube containing particles with the polymer in the solvent.

An electrophotographic member, such as a fuser member, can be formed by applying the formed coating mixture of the boron nitride nanotube particles and polymer in a solvent to a supporting substrate using known spray coating methods, and flow coating processes.

Specific embodiments will now be described in detail. These examples are intended to be illustrative, and not limited to the materials, conditions, or process parameters set forth in these embodiments. All parts are percentages by solid weight unless otherwise indicated.

### Example I

There is prepared a fuser member by mixing 0.5 weight percent of the boron nitride nanotubes available from BNNT, LLC, Newport News, Va. as BNNT P1 Beta and 99.5 weight percent of the fluoropolymer TEFLON PFA® (polyfluoroalkoxypolytetrafluoroethylene) available from E.I. DuPont, followed by flow coating the mixture resulting on a polyimide supporting substrate layer of about 70 microns thick.

### Example II

A fuser member is prepared by flow coating the Example I mixture of the boron nitride nanotubes (BNNT), and the fluoropolymer TEFLON PFA® (polyfluoroalkoxypolytetrafluoroethylene) in methyl ethyl ketone (MEK) at about 40 weight percent solids, on a polyimide supporting substrate where the polyimide is represented by the following formula/structure

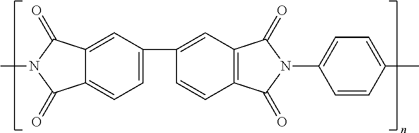

where n is about 300, followed by heating and baking at 250° C. for 30 minutes, and then further heating at 350° C. for 8 minutes, then cooling to room temperature of about 25° C. resulting in the PFA/BNNT top coat situated on the polyimide substrate.

The enhanced thermal conductivity of the above prepared boron nitride nanotubes containing fuser members can result in a drop in the temperature needed to satisfactorily fuse a toner image to a support. Therefore, it is believed that these fuser members can accomplish the same or equivalent fusing of a toner image to a support sheet at a lower fusing temperature than fusing members free of boron nitride nanotubes. The lower fusing temperature is advantageous since the fuser member consumes less energy, does not dry out paper, hence less curl, achieves improved toner fix and excellent toner coalescence for the same dwell time, extends the fuser member life, reduces power requirements at machine start up and while operating the fuser system.

Also, it is believed that the enhanced thermal conductivities of the disclosed boron nitride nanotubes fuser members will enable a combination of more rapid fusing speeds, an increase in the toner fusing temperature latitude, stability up to 900° C., robust mechanical properties, and the use of lower cost toners with higher melting temperatures.

Additionally, it is believed that the disclosed boron nitride nanotube fusing members withstand, without significant degradation in their physical properties, a high processing temperature of, for example, greater than about 500° C. and, more specifically, from about 600° C. to about 900° C.; high mechanical strength, improved heat conducting properties which improve the thermal efficiency of a fusing system, and tailored electrical properties.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A fuser member comprising a boron nitride nanotube component.

2. A fuser member in accordance with claim 1 further including a supporting substrate layer, and an optional intermediate polymer layer situated between the boron nitride nanotube component in the configuration of a layer and the supporting substrate.

3. A fuser member in accordance with claim 1 wherein the boron nitride nanotube component has an average outside diameter of from about 1 nanometer to about 100 nanometers, an average length of from about 10 microns to about 500 microns as determined by SEM measurements, and a surface area of from about 50 m²/g to about 500 m²/g as determined by BET analysis.

4. A fuser member in accordance with claim 1 further containing a fluoropolymer.

5. A fuser member in accordance with claim 4 wherein the fluoropolymer is selected from the group consisting of i) a copolymer of vinylidenefluoride and hexafluoropropylene; ii) a terpolymer of vinylidenefluoride, hexafluoropropylene and tetrafluoroethylene; and iii) a tetrapolymer of vinylidenefluoride, hexafluoropropylene, tetrafluoroethylene, and a cure site monomer.

6. A fuser member in accordance with claim 4 wherein the fluoropolymer is a polyfluoroalkoxypolytetrafluoroethylene.

7. A fuser member in accordance with claim 4 wherein said boron nitride nanotube component is present in an amount of from about 0.01 weight percent to about 10 weight percent based on the solids, and said fluoropolymer is present in an amount of from about 99.99 weight percent to about 90 weight percent based on the solids.

8. A fuser member in accordance with claim 4 wherein said boron nitride nanotube component is present in an amount of from about 0.1 to about 5 weight percent of the solids.

9. A fuser member in accordance with claim 4 wherein said boron nitride nanotube component is present in an amount of from about 0.05 to about 1 weight percent of the solids.

10. A fuser member in accordance with claim 2 wherein said intermediate polymer layer is present.

11. A fuser member in accordance with claim 2 wherein said supporting substrate is a polyimide as represented by at least one of the following formulas/structures 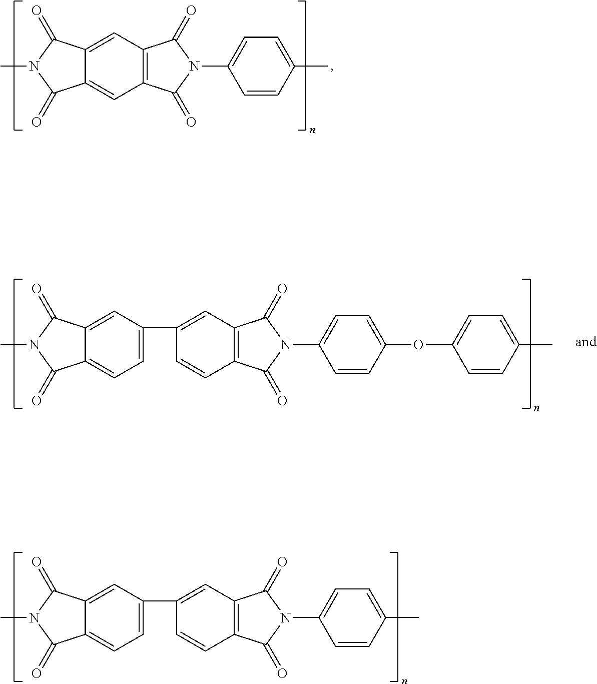
wherein n represents the number of repeating groups.

12. A fuser member in accordance with claim 11 wherein n is from about 5 to about 3,000, or wherein n is from about 200 to about 1,200.

13. A xerographic fuser member comprising a layer comprising a mixture of boron nitride nanotubes and a fluoropolymer.

14. A xerographic fuser member in accordance with claim 13 wherein said boron nitride nanotube particles are present in an amount of from about 0.01 to about 10 weight percent based on the solids, and said fluoropolymer is present in an amount of from about 99.99 weight percent to about 90 weight percent based on the solids.

15. A xerographic fuser member in accordance with claim 13 wherein the fluoropolymer is a polyfluoroalkoxypolytetrafluoroethylene.

16. A xerographic fuser member in accordance with claim 13 wherein the fluoropolymer is i) a copolymer of vinylidenefluoride and hexafluoropropylene; ii) a terpolymer of vinylidenefluoride, hexafluoropropylene and tetrafluoroethylene; and iii) a tetrapolymer of vinylidenefluoride, hexafluoropropylene, tetrafluoroethylene and a cure site monomer.

17. A fuser member comprising in the configuration of a layer a mixture of a plurality of boron nitride nanotubes present in an amount of from about 0.01 weight percent to about 10 weight percent of the solids, and a fluoropolymer present in an amount of from about 99.99 weight percent to about 90 weight percent of the solids.

18. A fuser member in accordance with claim 17 wherein the fluoropolymer is a polyfluoroalkoxypolytetrafluoroethylene.

19. A fuser member in accordance with claim 17 further including a polyimide supporting substrate.

20. A fuser member in accordance with claim 17 wherein the fluoropolymer is a copolymer of vinylidenefluoride and hexafluoropropylene; a terpolymer of vinylidenefluoride, hexafluoropropylene and tetrafluoroethylene; and a tetrapolymer of vinylidenefluoride, hexafluoropropylene, tetrafluoroethylene, and a cure site monomer.

21. A fuser member in accordance with claim 17 wherein the boron nitride nanotube components have an average outside diameter of from about 1 nanometer to about 100 nanometers, an average length of from about 10 microns to about 500 microns as determined by SEM measurements, and a surface area of from about 50 m²/g to about 500 m²/g as determined by BET analysis.
